(19) United States
(12) Patent Application Publication
(10) Pub. No.: US 2022/0408707 A1
(43) Pub. Date: Dec. 29, 2022

(54) FISHING JIG

(71) Applicant: Li-Tech Lures LLC, Forest Lake, MN (US)

(72) Inventor: Philip Litecky, Forest Lake, MN (US)

(73) Assignee: Li-Tech Lures LLC, Forest Lake, MN (US)

(21) Appl. No.: 17/845,246

(22) Filed: Jun. 21, 2022

Related U.S. Application Data
(60) Provisional application No. 63/215,235, filed on Jun. 25, 2021.

(51) Int. Cl. A01K 85/00

(52) U.S. Cl. CPC A01K 85/1821

(57) ABSTRACT

A fishing jig and method are disclosed. The fishing jig includes a head, a body, and a tail having proximal and distal ends and a plurality of converging edges disposed on the tail. The plurality of converging edges are separated at the proximal end at the body and converge along a length of the tail to a point of convergence at the distal end. Operably placing the jig on a hook in a first configuration controls movement of the tail in a vertical axis and inhibits movement of the tail in a horizontal axis while jigging. Operably placing the jig on the hook in a second configuration controls movement of the tail in the horizontal axis and inhibits movement of the tail in the vertical axis while jigging.

### PRIORITY STATEMENT

This application claims priority to U.S. Provisional Patent Application No. 63/215,235 filed on Jun. 25, 2021, titled FISHING JIG, all of which is hereby incorporated by reference in its entirety.

### FIELD OF THE DISCLOSURE

The present disclosure relates to jigging lures for fishing. More particularly, but not exclusively, the present disclosure relates to a jigging lure apparatus and method for use in fishing and having a unique lure tail geometry for improving desired lure movement.

### BACKGROUND

Fishing lures are commonly used in fishing practices. Generally, fishing lures are small, artificial objects resembling fish prey and are attached to the end of a hook tied to a fishing line. Fishing lures can be made of rubber, plastic, metal, or a combination thereof, and contemplates various shapes, sizes, colors, shiny or reflective materials, and even lights such as LEDs. Furthermore, lures can be weighted and enabled to move, spin, or vibrate to attract fish. The purpose of a fishing lure is to attract fish to an angler's fishing line. There are a variety of fishing lures available in the industry such as plugs, spinnerbaits, spoons, fly lures, and jigs. A variety of soft plastic lures are also commonly used and generally contemplate a molded shape or tube made of solid flexible plastic. Soft plastic lures are available in a variety of types such as worms, stick baits, creature baits, craws, tube baits, trailers, jerkbaits, grubs, and jigs. Soft baits can include various appendages such as fins, antennae, claws, legs, and tails to resemble different types of prey. Furthermore, soft baits may incorporate varying tail characteristics such as curly tail, paddle tail, straight tail, split tail, single tail, and double tail.

Lures are used in conjunction with a hook, such as a jig lure used in conjunction with a jig hook, which is pierced through the lure, the hook being tied to a fishing line and cast by an angler into the water with the attached lure. Using various strategies and motions depending on the type of hook and lure utilized by the angler as well as the variety of fish targeted, the angler attempts to make the lure imitate the motion and appearance of live bait in the water to attract fish. However, modern lures appear artificial in movement which present difficulties in successful fishing as some fish species do not respond well to these lures and might avoid them. Additionally, modern lures may only efficiently work where an abundant amount of fish are present as they are less likely to attract fish than live bait, requiring anglers to expend extra time and energy locating areas heavily populated with fish, and further requiring anglers to expend time and energy discerning which types of lures are most and/or least effective in a certain area. Further still, modern lures may address movement shortcomings in one direction, such as horizontal or vertical, but fail to address multidirectional movement requirements. Other lures may be well balanced and address many movement deficiencies, however they sacrifice other appeals, such as the visual appeal or imitation of live fish or bait, in their design and construction. Additionally, modern lures may address both movement and visual appeal deficiencies, however they must be continuously worked and monitored as they may not remain in a desired orientation when not being worked or jigged, causing the user to endlessly attend to the lure.

Therefore, what is needed is a fishing lure that more closely resembles the natural movement of live bait. And preferably what is needed is a fishing jig that more closely resembles the natural movement of live bait. The present disclosure addresses the deficiencies in the art by providing a fishing lure designed with a diamond tail geometry. In a preferred aspect, the present invention provides a fishing jig having a diamond shaped tail geometry. The diamond tail geometry promotes uniaxial motion for the tail and stabilizes the physical orientation of the lure, making the lure display a more natural motion in water and appear more realistic to a fish. A user of the lure can control this action by orienting the lure properly on the hook. One orientation will promote the tail to move in the vertical axis while inhibiting movement on the horizontal axis. Another orientation will promote movement on the horizontal axis while inhibiting movement on the vertical axis. Further still, the lure may be oriented on any axis in the diagonal planes to promote movement on a desired axis and inhibit movement on another. It is contemplated that a lure may be oriented at any degree on any axis to achieve desired movement results.

### SUMMARY

Therefore, it is a primary object, feature, or advantage of the present disclosure to improve over the state of the art by providing a fishing lure that incorporates unique, natural movements that more closely resemble the movement of live bait.

It is a further object, feature, or advantage of the present disclosure to provide a fishing lure that is easy to manufacture.

It is a further object, feature, or advantage of the present disclosure to provide a fishing lure that is easy to use.

Another object, feature, or advantage of the present disclosure is to provide a fishing method and lure that promotes uniaxial movement.

Another object, feature, or advantage of the present disclosure is to provide a fishing lure with a variety of characteristics considered attractive to fish.

It is another object, feature, or advantage of the present disclosure to provide a fishing lure that can be utilized for jigging or jig fishing.

A still further object, feature, or advantage of the present disclosure is to provide a fishing lure with a tail geometry that generally consists of a rhombus.

It is a still further object, feature, or advantage of the present disclosure to provide a fishing lure with tail having chamfered edges.

It is another object, feature, or advantage of the present disclosure to provide a fishing lure that is made of soft plastic.

Another object, feature, or advantage of the present disclosure is to provide a fishing lure with at least one parabolic-shaped end.

Yet another object, feature, or advantage of the present disclosure is to provide a fishing lure with a tail geometry that permits movement of the tail in a vertical axis and inhibits movement of the tail in a horizontal axis in a first configuration and permits movement of the tail in a horizontal axis and inhibits movement of the tail in a vertical axis in a second configuration.

Another object, feature, or advantage of the present disclosure is to provide a fishing lure with a tail geometry that permits movement of the tail in a desired axis in any direction such as a diagonal axis while inhibiting movement of a tail in an undesired axis.

Still another object, feature, or advantage of the present disclosure is to provide a fishing lure with a tail geometry that enables a user to control movement of the lure in accordance with an orientation chosen by a user.

Yet another object, feature, or advantage of the present disclosure is to provide a fishing lure that simulates the natural motion of a creature in water.

According to at least one aspect, a fishing jig is disclosed. The fishing jig may include a head, a body, and a tail having proximal and distal ends. The fishing jig may also include, by way of example, a plurality of converging edges disposed on the tail, wherein the plurality of converging edges are separated at the proximal end at the body and converge along a length of the tail to a point of convergence at the distal end.

According to at least one other aspect, a fishing jig is disclosed. The fishing jig may include a head, a body, and a tail having proximal and distal ends. At least one configuration of the jig on a hook may permit movement of the tail in a vertical axis and inhibit movement of the tail in a horizontal axis while jigging. Another configuration of the jig on the hook may permit movement of the tail in the horizontal axis and inhibit movement of the tail in the vertical axis while jigging.

According to still another aspect, a method for a fishing jig is disclosed. The method may include the step, such as, for example, providing a fishing jig having a head, a body, a tail having proximal and distal ends, and a plurality of converging edges disposed on the tail, operably placing the jig on a hook in a first configuration for controlling movement of the tail in a vertical axis and inhibiting movement of the tail in a horizontal axis while jigging, and operably placing the jig on the hook in a second configuration for controlling movement of the tail in the horizontal axis and inhibiting movement of the tail in the vertical axis while jigging. It is further contemplated that a method may include operably placing the jig on a hook in any configuration, for example, in a diagonal configuration, for controlling movement of the tail in a desired axis and inhibiting movement of the tail in an undesired axis while jigging.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is an isometric view of a fishing lure of the present disclosure.

FIG. 2 is a left side view of a fishing lure of the present disclosure.

FIG. 3 is a right side view of a fishing lure of the present disclosure.

FIG. 4 is a top view of a fishing lure of the present disclosure.

FIG. 5 is a bottom view of a fishing lure of the present disclosure.

FIG. 6 is a front view of a fishing lure of the present disclosure.

FIG. 7 is a rear view of a fishing lure of the present disclosure.

FIG. 8 is a left side view of a fishing lure of the present disclosure displaying one exemplary configuration of a lure attached to a fishing hook for generating uniaxial tail movement in a single plane.

FIG. 9 is a top view of a fishing lure of the present disclosure displaying another exemplary configuration of a lure attached to a fishing hook for generating uniaxial tail movement in a single plane.

FIG. 10 shows a flowchart illustrating a method for a fishing lure in accordance with an illustrative aspect of the present disclosure.

FIG. 11 shows another flowchart illustrating a method for a fishing lure in accordance with an illustrative aspect of the present disclosure.

### DETAILED DESCRIPTION

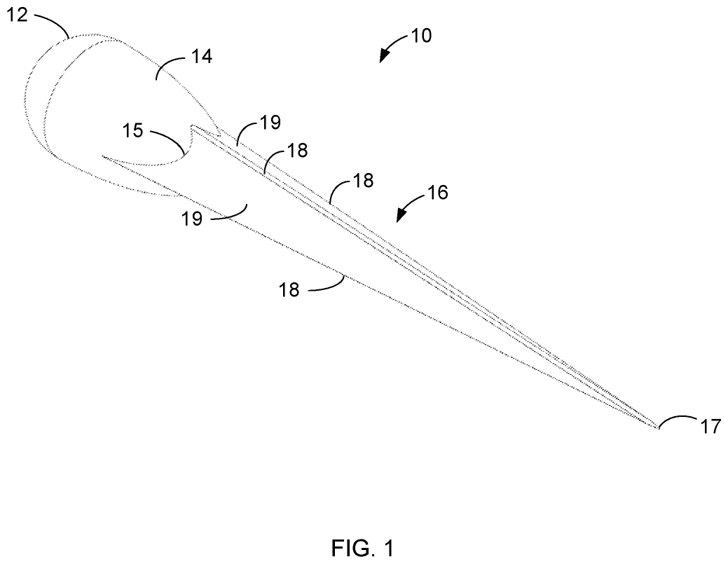

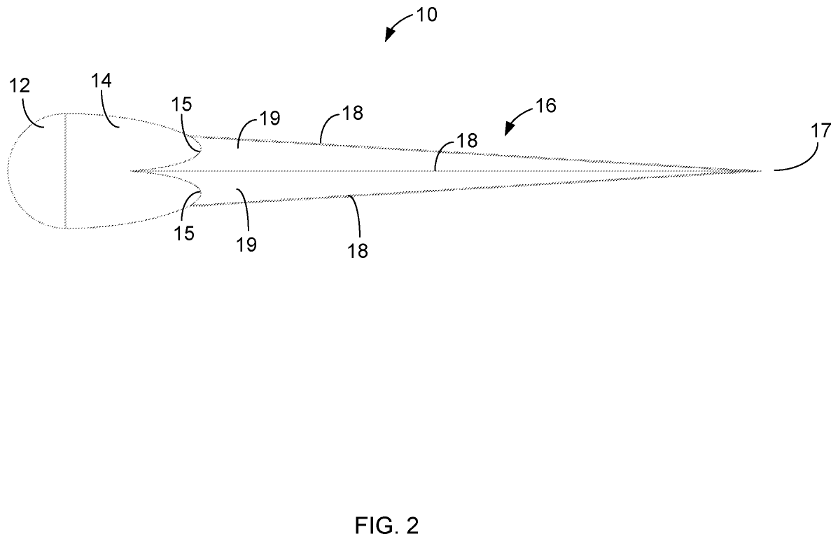

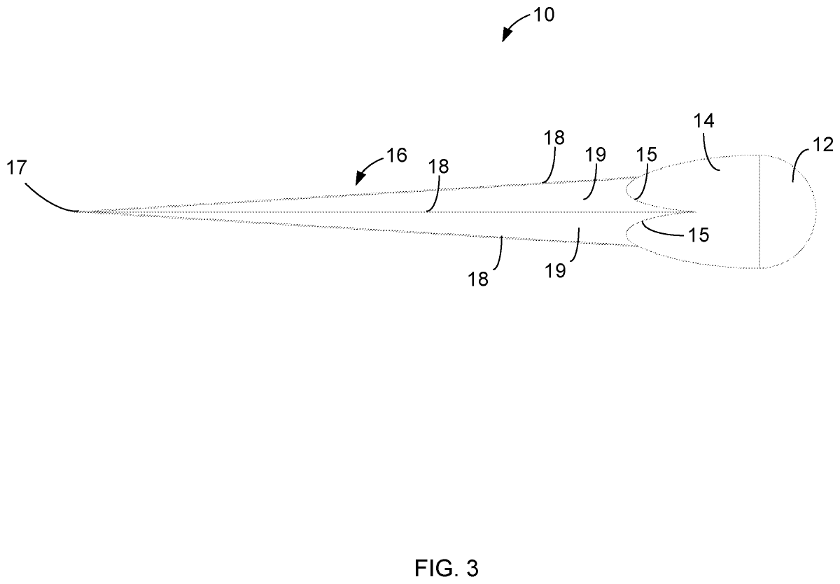

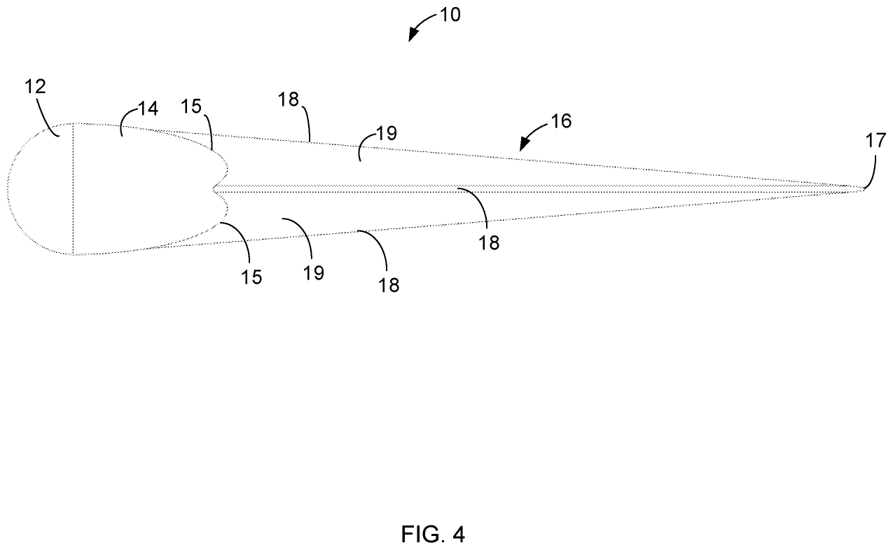

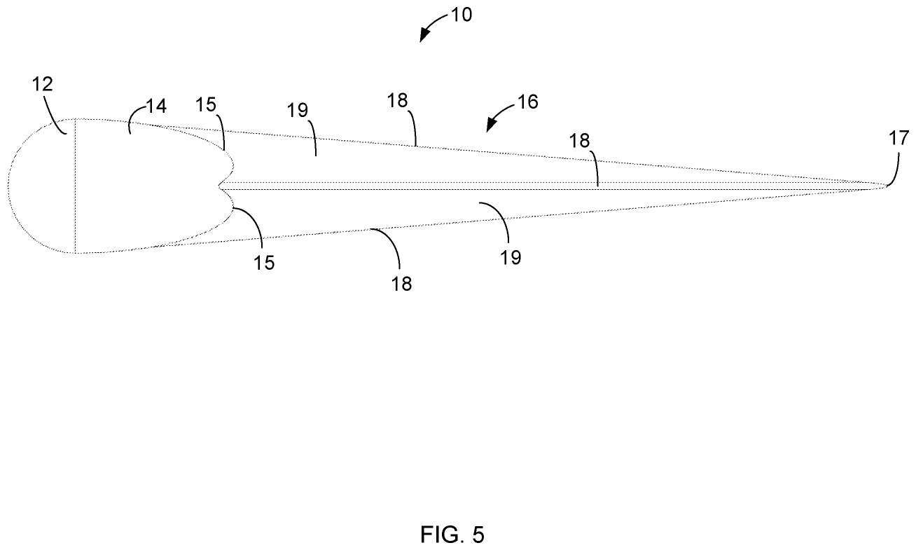

FIGS. 1-11 provide various pictorial illustrations for exemplary aspects of a fishing lure and method in accordance with the objects, features, and advantages of the present disclosure.

The present disclosure contemplates many different apparatuses and varying arrangements, methods and systems for a fishing lure as well as commercialization and use. Representative applications of methods and systems are described in this section as well as apparatus mechanisms and structures. These examples are provided solely to add context and aid in understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the apparatus, system, and method as well as the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

As used herein, the term “lure” is directed towards a fishing lure. However, it is contemplated that lures of any type, including but not limited to, various lures such as jigs, plugs, crankbaits, spinnerbait lures, spoons, flies, soft plastic lures, hard plastic lures, or any other type of lure may also be utilized. Additionally, the disclosure is mostly directed towards fishing, and in particular ice fishing for panfish, however, it is contemplated that the disclosed may be used for various other types of fishing, including but not limited to bait fishing, fly-fishing, bait casting, spinning, trolling, or any other type or method of fishing. It is contemplated the disclosure may be directed to fishing for various types of fish including but not limited to panfish, sunfish, Yellow perch, perch, crappies, whitefish, walleye, largemouth bass, smallmouth bass, Rainbow trout, Brown trout, trout, pike, Northern Pikes, Pickerel, sauger, Tulibee, Eelpout, Bluegills, or any other type of fish.

FIG. 1 illustrates an isometric view of an exemplary fishing lure 10 of the present disclosure. The fishing lure 10 may have a head portion 12, a body portion 14, and a tail portion 16. An adjoining edge 15 is disposed on fishing lure 10 and connects and is interdisposed between the head 12 and/or body 14 to the tail 16. However, it is contemplated that in another aspect, adjoining edge 15 may be absent and the head 12 and/or body 14 may be fluidly or seamlessly, such as via a seamless surface, connected to the tail 16. The fishing lure 10 may made of a variety of materials, such as rubber or soft plastic, suitable for facilitating different motions and forms of movement. The fishing lure 10 can also include various colors including but not limited to neon, fluorescent, glow in the dark, translucent, opaque, or other colors that may be considered attractive to fish. The fishing lure 10 may also incorporate various materials including but not limited to glitter, reflective flakes, opaque flakes, reflective specks, opaque specks, lights, or any other material that may be considered attractive to a fish. Additionally, the fishing lure 10 may incorporate fish attractant scents, including but not limited to garlic, salt, anise, or other scents that may be considered attractive to a fish. Further still, fishing lure 10 may include additives, for example chemical additives, such as sinking powder, salt, softener, floating powder, or other additives that may enhance fishing lure 10 attractiveness to fish.

As further shown in FIG. 1, the head 12 and body 14 of the fishing lure 10 in the present disclosure may be parabolically shaped. In other aspects, the head 12 and/or body 14 may be a variety of shapes and sizes, including but not limited to flat, spherical, oblong, tapered, triangular, pyramidical, cylindrical, octagonal, asymmetrical, or other such shapes and/or sizes. In other aspects, the head 12 and/or body 14 may feature different shapes on opposing ends or sides of the body. For example, one aspect could include a body with one end being parabolically shaped and another end being triangular or pyramidical. In further varying aspects, the head 12 and/or body 14 could be textured, slitted, ridged, coiled, etched, embossed, cross-hatched, or incorporate other characteristics or design textures. It is further contemplated that the head 12 and the body 14 may be designed to provide a fluid surface design between them thereby appearing as a single portion of fishing lure 10.

Still further shown in FIG. 1, the tail 16 of the fishing lure 10 may have a plurality of converging edges 18 that are separated at the proximal end at the body and converge along a length of the tail 16 to a point of convergence 17 at the distal end. In at least one aspect, the tail 16 may be made of smooth soft plastic. However, in other aspects, the tail 16 may be made of different materials such as rubber, elastic, or other materials that promote a variety of desired movements or otherwise inhibit undesired movements. In yet other aspects, different textures may be incorporated into the tail 16 such as slits, ridges, etches, cross-hatches, bumps, perforations, or other designs that may attract and appeal to fish. Further, other aspects of the tail 16 could include attached tentacles, fins, legs, or other appendages that emulate the appearance of fish prey. Additionally, the tail 16 of fishing lure 10 may incorporate fish attractant scents, including but not limited to garlic, salt, anise, or other scents that may be considered attractive to a fish. The converging edges 18 of the tail 16 of the fishing lure 10 may be chamfered, and an opposing pair of converging edges 18 may be configured to extend generally to a middle portion of the body 14 and the proximal end of the tail 16 may be connected to the parabolic-shaped end of the body 14. In one configuration, the plurality of converging edges could be operably configured to provide uniaxial movement of the tail 16 while jigging.

A surface 19 is disposed between opposing converging edges 18 of the tail 16. The surface 19 may be a concave surface, however it is contemplated that surface 19 may have other surface shapes including but not limited to curved, flat, convex, concave, symmetrical, asymmetrical, or any other conceivable surface shape. The surface 19 may also be a smooth surface, but it is contemplated that surface 19 may be textured, undulated, slitted, ridged, coiled, etched, embossed, cross-hatched, or incorporate other characteristics or design textures. Further still, the tail 16, converging edges 18, and surface 19 may be made of the same material such as, for example, soft plastic. However, it is contemplated that tail 16, converging edges 18, and surface 19 may be each be made of different materials or any combination or arrangement of materials. For example, it is contemplated that converging edges 18 may made of a slightly harder plastic than surface 19 as to potentially provide reinforcement to tail 16 and/or fishing lure 10 shape. Further still, it is contemplated that any part or portion of fishing lure 10 may incorporate features, textures, designs, materials, characteristics, or additives that may be absent in other portions, and the fishing lure 10 may incorporate any combination of features, textures, designs, materials, characteristics, additives, or the like. For example, head 12 may have a texture such as a smooth texture and the body 14 may have a texture such as a cross-hatched texture.

Fishing lure 10 may be of varying lengths for targeting a variety of species of fish. For example, fishing lure 10 may be a length of 1.5 inches for targeting panfish, or fishing lure 10 may be a length of 1 inch for targeting especially small panfish. It is also contemplated that fishing lure 10 may of a length of 3 inches for targeting larger fish such as walleye and bass. It is further contemplated that fishing lure 10 may be of any length or width for targeting a variety of species of fish. Further still, fishing lure 10 may be scaled up or down while retaining geometry for targeting a variety of fish.

FIGS. 1-9 illustrate various views of the fishing lure 10 of the present disclosure. As shown in the figures, fishing lure 10 may have a head 12, a body 14, and a tail 16 having proximal and distal ends. The body 14 of the fishing lure 10 may have at least one parabolic shaped end. The tail 16 of the fishing lure 10 may have a plurality of converging edges 18 that are separated at the proximal end of the body 14 and converge along a length of the tail 16 to a point of convergence 17 at the distal end. The opposing pair of converging edges 18 may extend generally to a middle portion of the body 14 of the fishing lure 10.

In at least one aspect, the plurality of converging edges 18 of the tail 16 may be converging and the cross section of the tail 16 may generally form the shape of a rhombus. The tail 16 geometry and structure promote uniaxial movement of the tail 16 while jigging, wherein a first configuration of the lure 10 on a hook 20 permits movement of the tail 16 in a vertical axis and inhibits movement of the tail 16 in a horizontal axis while jigging, and wherein a second configuration of the lure 10 on a hook 20 permits movement of the tail 16 in a horizontal axis and inhibits movement of the tail 16 in the vertical axis while jigging. The motion of the lure 10 therefore appears more realistic and attractive to fish while jigging.

A fishing line is typically connected to a connection end 21 of a hook 20 in accordance with what is common in the industry (e.g., knot, ring, snap, etc.,) and the hook 20 is pierced through the head 12 of the fishing lure 10 so that it runs through the center of the body 14 and emerges from the body 14 at the proximal end of the tail 16. An angler may operably place the lure 10 on the hook 20 in a first configuration for controlling movement of the tail 16 in a vertical axis and inhibiting movement of the tail 16 in a horizontal axis while jigging for the desired effect of the lure 10 appearing more natural in movement. An angler may otherwise operably place the lure 10 on the hook 20 in a second configuration for controlling movement of the tail 16 in the horizonal axis and inhibiting movement of the tail 16 in the vertical axis while jigging for the desired effect of the lure 10 appearing more natural in movement. A person skilled in the art would recognize that various motions and techniques can be utilized while jigging depending on the variety of fish being targeted. For example, an angler may repeatedly raise and lower a fishing rod with the hook and lure attached in the water, creating quick, snappy vertical motions to attract the attention of fish.

In the present disclosure, an angler would present the fishing lure 10 attached to a hook 20, connected to a fishing line by means of a connection end 21, in one configuration that may include the plurality of converging edges 18 of the tail 16 in the horizontal axis and utilize generally vertical jigging motions to attract fish. Also described in the present disclosure, an angler would present the fishing lure 10 attached to a hook 20, connected to a fishing line by means of a connection end 21, in a second configuration that may include the plurality of converging edges 18 of the tail 16 in the vertical axis and utilize generally horizontal jigging motions to attract fish. In at least one aspect, the lure 10 may incorporate soft plastic to facilitate movement in the first and second configuration as previously described, while promoting uniaxial movement of the tail 16 to inhibit undesired movement while jigging. Other aspects of the disclosure could be utilized in various ways by an angler familiar with jigging practices, strategies, and techniques.

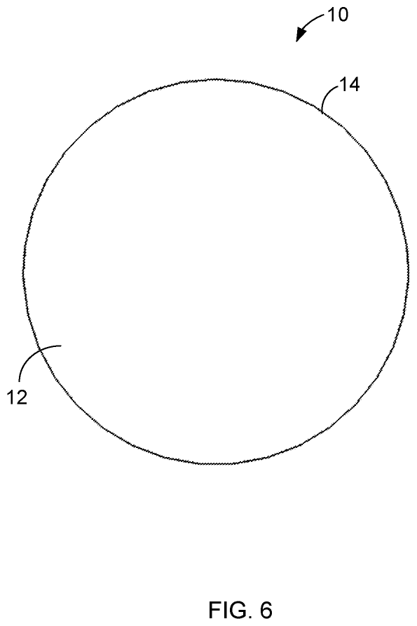

FIG. 6 illustrates a front view of the fishing lure 10 of the present disclosure. The head 12 of the lure 10 may be generally spherical in shape and have a diameter equal to the body 14 in at least one aspect. However, in other aspects, the head 12 may be different shapes and sizes including but not limited to triangular, rectangular, diamond, square, or other shapes and sizes. In further different aspects, the head 12 of the lure 10 may protrude varying distances from the body 14 for the purpose of better fitting a variety of hooks or other purposes. It is further contemplated that the head 12 may also include a projection or other elements of manufacturing, such as residual features from injection molding or other manufacturing processes, which may be removed prior to use of the lure 10. Furthermore, the body 14 of the lure 10 may be of various sizes for the purpose of better fitting a variety of hooks, increasing or decreasing overall weight, or other purposes not listed herein.

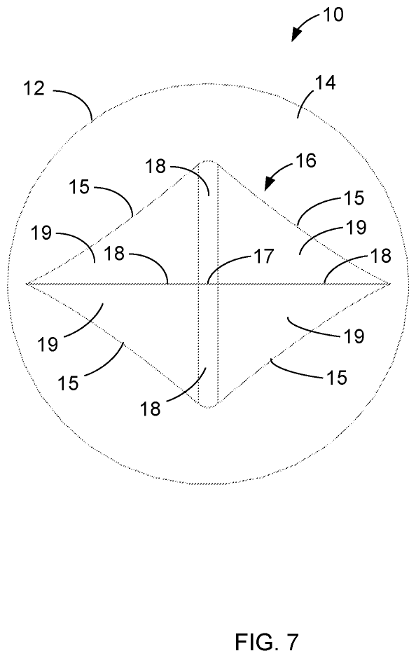

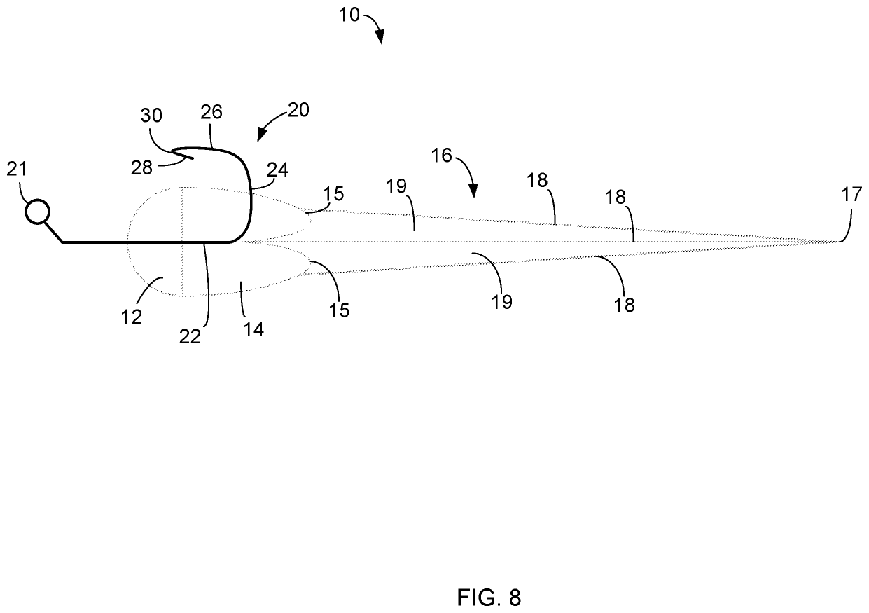

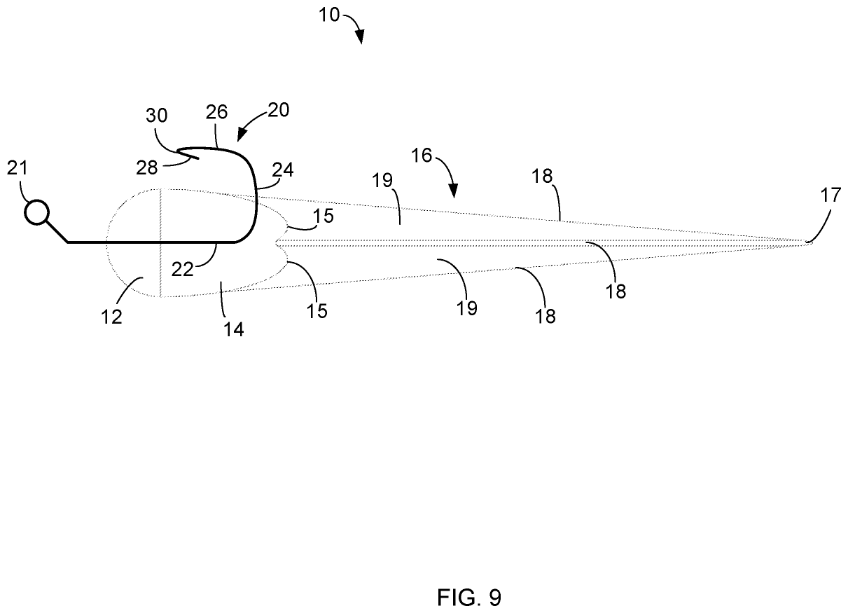

FIG. 7 illustrates a rear view of the fishing lure 10 of the present disclosure. The fishing lure 10 has a tail 16 that incorporates converging edges 18 that geometrically form the shape of a rhombus at the tail 16 cross section. The geometric design of the tail 16 promotes uniaxial movement of the tail 16 in a vertical axis and inhibits movement of the tail 16 in a horizontal axis in a first configuration while jigging. Furthermore, the geometric design of the tail 16 promotes uniaxial movement of the tail 16 in a horizontal axis and inhibits movement of the tail 16 in the vertical axis in a second configuration while jigging. It is further contemplated that other configurations such as, for example, any configuration in a diagonal axis may be utilized to promote uniaxial movement of the tail 16 in one direction or axis and inhibit movement of the tail 16 in another direction or axis. A user of fishing lure 10 can control the action and movement of fishing lure 10 depending on how the user attaches the lure 10 on the hook 20 (see FIGS. 8-9). Though the present aspect features converging edges 18 that form a rhombus at the cross section of the tail 16, other aspects may feature converging edges that form a variety of other parallelograms or quadrilaterals at the tail 16 cross section.

FIG. 8 illustrates a left side view of a fishing lure 10 of the present disclosure displaying one exemplary aspect of a lure 10 attached to a fishing hook 20. The fishing hook 20 may have a connection end 21 utilized to connect a fishing line to the fishing hook 20. In other aspects, the fishing hook 20 may be a weighted hook made of tungsten, lead, or other materials suitable for fishing practices. The hook 20 may also incorporate a design that could mimic a head of a bait fish or other creature that may resemble fish prey. The connection end 21 may include an eyelet, ring, snap, clip, or other suitable fishing tackle for connecting a fishing line to a fishing hook used in the industry. In other aspects, a hook head or head weight (not shown) may be present on hook 20 where the connection end 21 is located, and connection end 21 may be located on a hook head or head weight of a hook 20. A point 30 of a fishing hook 20 may be inserted into the proximal end, such as the head 12, of a fishing lure 10 and pushed through the center of the body 14 of the fishing lure 10 and rotated about the bend 24 of the fishing hook 20 until the point 30 exits the side of the body 14 in the direction of the top side of the lure 10 near the proximal end of the tail 16 of the fishing lure 10 and the hook shank 22 is centered in the body 14 of the lure 10. The throat 26, barb 28, and point 30 of the hook 20 may be oriented outside the body 14 of the lure 10 and extend from the top side of the fishing lure 10 wherein the point 30 of the hook 20 generally faces the direction of the head 12 of the fishing lure 10. In another aspect, the fishing hook 20 may be inserted into a fishing lure 10 as described above, however, the point 30 may exit the side of the body 14 in the direction of the bottom side of the lure 10 near the proximal end of the tail 16 of the fishing lure 10. According to this aspect, the hook shank 22 of the fishing hook 20 may be centered in the body 14 of the lure 10, and the throat 26, barb 28, and point 30 of the hook 20 may be oriented outside the body 14 of the lure 10 and extend from the bottom side of the fishing lure 10 wherein the point 30 of the hook 20 generally faces the direction of the head 12 of the fishing lure 10. A hook 20 that includes a hook head or head weight can be inserted into fishing lure 10 as described, however the hook head or head weight would be located proximate the head 12 of fishing lure 10 instead of the connection end 21. According to at least one aspect, the configurations described would promote uniaxial motion of the tail 16 of the fishing lure 10 on a vertical axis while inhibiting motion of the tail 16 of the fishing lure 10 on a horizontal axis. It is further contemplated that, in other aspects, different configurations may be utilized to promote uniaxial motion of the tail 16 of the fishing lure 10 on one axis, such as, for example, a diagonal axis, while inhibiting motion of the tail 16 of the fishing lure 10 on another axis. Other configurations may include varying degrees of orientation of the fishing lure 10 on a hook 20, such as a 45-degree angle, or any other conceivable angle. A user of fishing lure 10 can control the action and movement of fishing lure 10 depending on how the user attaches the lure 10 on the hook 20. Other aspects and configurations of the disclosure could be utilized in various ways by an angler familiar with jigging practices, strategies, techniques, and hook orientations.

FIG. 9 illustrates top view of a fishing lure 10 of the present disclosure displaying another exemplary aspect of a lure 10 attached to a fishing hook 20. The fishing hook 20 may have a connection end 21 utilized to connect a fishing line to the fishing hook 20. In other aspects, the fishing hook 20 may be a weighted hook made of tungsten, lead, or other materials suitable for fishing practices. The hook 20 may also incorporate a design that could mimic a head of a bait fish or other creature that may resemble fish prey. The connection end 21 may include an eyelet, ring, snap, clip, or other suitable fishing tackle for connecting a fishing line to a fishing hook used in the industry. A point 30 of a fishing hook 20 may be inserted into the head 12 of a fishing lure 10 and pushed through the center of the body 14 of the fishing lure 10 and rotated about the bend 24 of the fishing hook 20 until the point 30 exits the side of the body 14 in the direction of the left side of the lure 10 near the proximal end of the tail 16 of the fishing lure 10 and the hook shank 22 is centered in the body 14 of the lure 10. The throat 26, barb 28, and point 30 of the hook 20 may be oriented outside the body 14 of the lure 10 and extend from the left side of the fishing lure 10 wherein the point 30 of the hook 20 generally faces the direction of the head 12 of the fishing lure 10. In another aspect, the fishing hook 20 may be inserted into a fishing lure 10 as described above, however, the point 30 may exit the side of the body 14 in the direction of the right side of the lure 10 near the proximal end of the tail 16 of the fishing lure 10. According to this aspect, the hook shank 22 of the fishing hook 20 may be centered in the body 14 of the lure 10, and the throat 26, barb 28, and point 30 of the hook 20 may be oriented outside the body 14 of the lure 10 and extend from the right side of the fishing lure 10 wherein the point 30 of the hook 20 generally faces the direction of the head 12 of the fishing lure 10. A hook 20 that includes a hook head or head weight can be inserted into fishing lure 10 as described, however the hook head or head weight would be located proximate the head 12 of fishing lure 10 instead of the connection end 21. According to at least one aspect, the configurations described would promote uniaxial motion of the tail 16 of the fishing lure 10 on a horizontal axis while inhibiting motion of the tail 16 of the fishing lure 10 on a vertical axis. It is further contemplated that, in other aspects, different configurations may be utilized to promote uniaxial motion of the tail 16 of the fishing lure 10 on one axis, such as, for example, a diagonal axis, while inhibiting motion of the tail 16 of the fishing lure 10 on another axis. Other configurations may include varying degrees of orientation of the fishing lure 10 on a hook 20, such as a 45-degree angle, or any other conceivable angle. A user of fishing lure 10 can control the action and movement of fishing lure 10 depending on how the user attaches the lure 10 on the hook 20. Other aspects and configurations of the disclosure could be utilized in various ways by an angler familiar with jigging practices, strategies, techniques, and hook orientations.

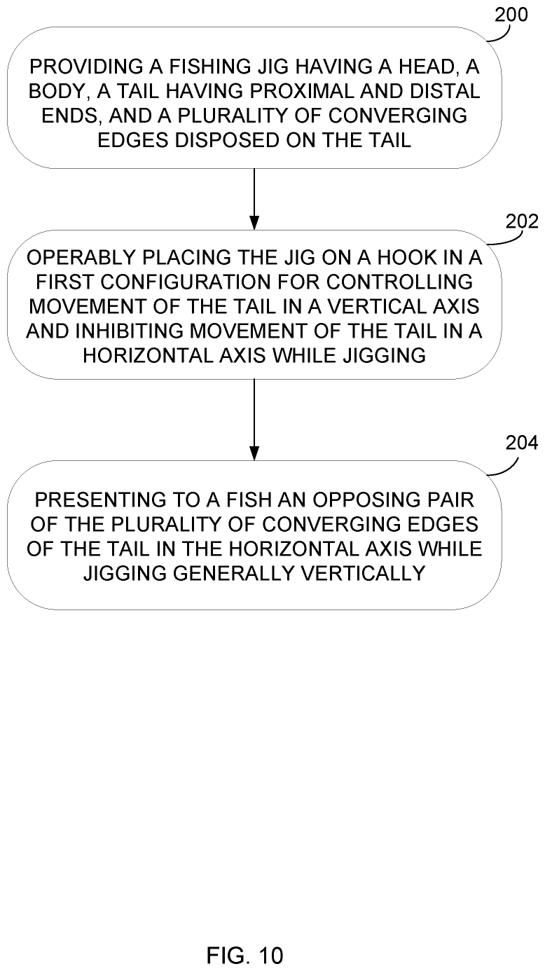

In at least one aspect of the present disclosure, a method for use of a fishing lure is shown in FIG. 10. The method may include steps, such as, providing a fishing jig having a head, a body, a tail having proximal and distal ends, and a plurality of converging edges disposed on the tail (Step 200), operably placing the jig on a hook in a first configuration for controlling movement of the tail in a vertical axis and inhibiting movement of the tail in a horizontal axis while jigging (Step 202), presenting to a fish an opposing pair of the plurality of converging edges of the tail in the horizontal axis while jigging generally vertically (Step 204). The plurality of converging edges 18 may be separated at the proximal end at the body 14 and converge along a length of the tail 16 to a point of convergence 17 at the distal end of the tail 16, and a cross section of the tail 16 may generally be a rhombus. The fishing lure 10 may be made of a soft plastic for facilitating movement in the first configuration. A user can control the action of the jig depending on how the user decides to hook the jig. The geometry of tail 16, which may include the converging edges 18, surface 19, and point of convergence 17, enables fishing lure 10 to resemble the natural movement and behavior of live bait in water. When fishing lure 10 is appropriately attached to a hook and placed in water, an angler may work or jig the lure in a vertical direction, and the movement of the tail 16 of fishing lure 10 will be inhibited horizontally while being enabled to move vertically, thus resembling the natural movement of live bait in water. As opposed to other modern lures, the unique geometry of tail 16 more closely resembles the tail shape and geometry of live bait or fish, thereby enabling fishing lure 10 to closely resemble the movement of live bait or fish when in water and worked or jigged by a user.

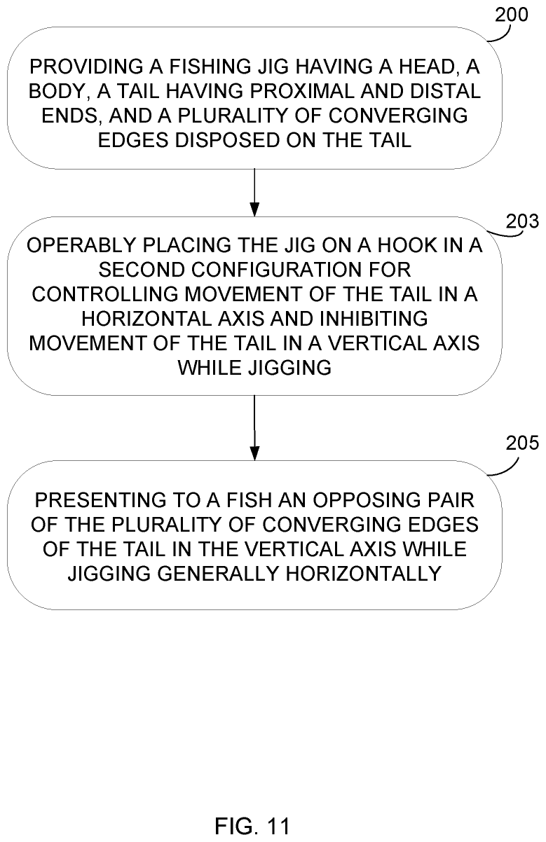

In another aspect of the present disclosure, a method for use of a fishing lure is shown in FIG. 11. The method may include steps, such as, providing a fishing jig having a head, a body, a tail having proximal and distal ends, and a plurality of converging edges disposed on the tail (Step 200), operably placing the jig on the hook in a second configuration for controlling movement of the tail in a horizontal axis and inhibiting movement of the tail in a vertical axis while jigging (Step 203), presenting to a fish an opposing pair of the plurality of converging edges of the tail in the vertical axis while jigging generally horizontally (Step 205). The plurality of converging edges 18 may be separated at the proximal end at the body 14 and converge along a length of the tail 16 to a point of convergence 17 at the distal end of the tail 16, and a cross section of the tail 16 may generally be a rhombus. The fishing lure 10 may be made of a soft plastic for facilitating movement in the second configuration. A user can control the action of the jig depending on how the user decides to hook the jig. The geometry of tail 16, which may include the converging edges 18, surface 19, and point of convergence 17, enables fishing lure 10 to resemble the natural movement and behavior of live bait in water. When fishing lure 10 is appropriately attached to a hook and placed in water, an angler may work or jig the lure in a horizontal direction, and the movement of the tail 16 of fishing lure 10 will be inhibited vertically while being enabled to move horizontally, thus resembling the natural movement of live bait in water. As opposed to other modern lures, the unique geometry of tail 16 more closely resembles the tail shape and geometry of live bait or fish, thereby enabling fishing lure 10 to closely resemble the movement of live bait or fish when in water and worked or jigged by a user.

While a first and second configuration are expressly discussed, it is contemplated that a third, fourth, or any number of configurations may be used in the method. The variety of configurations may include, for example, any configuration or orientation of a fishing jig in a diagonal axis for controlling movement of the tail in one desired direction and inhibiting movement of the tail in another undesired direction. The uniaxial movement of tail 16 is not limited to the horizontal and/or vertical axes and may be observed in any configuration or orientation when tail 16 placed on a hook 20 or in water. Tail 16 closely resembles the geometry and anatomy of a tail of a fish or live bait and enables the fishing lure 10 to behave in a manner that closely resembles the natural movement and behavior of live bait or fish in water when being worked or jigged by a user.

The disclosure is not to be limited to the particular aspects described herein. In particular, the disclosure contemplates numerous variations in fishing lures with a unique tail geometry and methods of use thereof. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A fishing lure, comprising:
a head, a body, and a tail having proximal and distal ends;
a plurality of converging edges disposed on the tail, wherein the plurality of converging edges are separated at the proximal end at the body and converge along a length of the tail to a point of convergence at the distal end.

2. The fishing lure of claim 1, wherein a cross section of the tail generally comprises a rhombus.

3. The fishing lure of claim 1, wherein one or more of the plurality of converging edges are chamfered.

4. The fishing lure of claim 1, wherein an opposing pair of the converging edges extend generally to a middle portion of the body.

5. The fishing lure of claim 1, wherein the body has at least one parabolic-shaped end.

6. The fishing lure of claim 5, wherein the proximal end of the tail is connected to the parabolic-shaped end of the body.

7. The fishing lure of claim 1, wherein the plurality of converging edges are operably configured to provide uniaxial movement of the tail while jigging.

8. A fishing jig, comprising:
a head, a body, and a tail having proximal and distal ends;
wherein a first configuration of the jig on a hook permits movement of the tail in a vertical axis and inhibits movement of the tail in a horizontal axis while jigging;
wherein a second configuration of the jig on the hook permits movement of the tail in the horizontal axis and inhibits movement of the tail in the vertical axis while jigging.

9. The jig of claim 8, further comprising:
a plurality of converging edges disposed on the tail, wherein the plurality of converging edges are separated at the proximal end at the body and converge along a length of the tail to a point of convergence at the distal end;

10. The fishing jig of claim 8, wherein a cross section of the tail generally comprises a rhombus.

11. The fishing jig of claim 9, wherein one or more of the plurality of converging edges are chamfered.

12. The fishing jig of claim 9, wherein an opposing pair of the converging edges extend generally to a middle portion of the body.

13. The fishing jig of claim 8, wherein the body has at least one parabolic-shaped end.

14. The fishing jig of claim 13, wherein the proximal end of the tail is connected to the parabolic-shaped end of the body.

15. A method for a fishing jig, comprising:
providing a fishing jig having a head, a body, a tail having proximal and distal ends, and a plurality of converging edges disposed on the tail;
operably placing the jig on a hook in a first configuration for controlling movement of the tail in a vertical axis and inhibiting movement of the tail in a horizontal axis while jigging;
operably placing the jig on the hook in a second configuration for controlling movement of the tail in the horizontal axis and inhibiting movement of the tail in the vertical axis while jigging.

16. The method of claim 15, wherein the plurality of converging edges are separated at the proximal end at the body and converge along a length of the tail to a point of convergence at the distal end of the tail.

17. The method of claim 15, wherein a cross section of the tail generally comprises a rhombus.

18. The method of claim 15, further comprising:
presenting to a fish an opposing pair of the plurality of converging edges of the tail in the horizontal axis while jigging generally vertically.

19. The method of claim 15, further comprising:
presenting to a fish an opposing pair of the plurality of converging edges of the tail in the vertical axis while jigging generally horizontally.

20. The method of claim 15, wherein the fishing jig comprises a soft plastic for facilitating movement in the first and second configuration.
